(19) United States
(12) Patent Application Publication
(10) Pub. No.: US 2026/0329357 A1
(43) Pub. Date: Oct. 22, 2026

(54) INTELLIGENT HIERARCHICAL ORCHESTRATION OF PREDICTIVE DATA CENTER COOLING FOR UPCOMING LARGE LANGUAGE MODEL (LLM) WORKLOADS

(71) Applicant: Dorian Cartwright, San Jose, CA (US)

(72) Inventor: Dorian Cartwright, San Jose, CA (US)

(21) Appl. No.: 19/542,236

(22) Filed: Feb. 17, 2026

Related U.S. Application Data
(60) Provisional application No. 63/982,023, filed on Feb. 13, 2026.

(51) Int. Cl. G06F 1/20

(52) U.S. Cl. CPC G06F 1/206

(57) ABSTRACT

Integrated data center thermal management are disclosed. A Workload Orchestrator analyzes metadata of an Artificial Intelligence (AI) job to determine a predicted thermal profile. A Cooling Orchestration Middleware (COM) translates this profile into localized cooling requirements. A Smart Liquid Distribution Manifold, featuring a plurality of IP-addressable micro-valves, adjusts coolant flow to individual computing blades in response to the localized cooling requirement prior to a measured temperature increase at the blade. The Workload Orchestrator can throttle or reschedule the AI job if the COM determines the required cooling exceeds available facility capacity. The predicted thermal profile accounts for the periodic synchronization phases of transformer-based Large Language Model (LLM) training.

### FIELD OF THE INVENTION

The present disclosure relates generally to data center infrastructure, and more specifically to a cross-layer control system that intelligently integrates Artificial Intelligence (AI) workload metadata with integrated data center cooling for Large Language Model (LLM) workloads.

### BACKGROUND

The rise in AI use has led to increased loads to data centers which are the cloud-infrastructure supporting the large-scale computing power needed for AI processes. These data centers include dense arrays of high-powered computing semiconductor chips that generate immense amounts of heat. Without proper cooling, processor performance can be throttled down to stay within preferred heat ranges.

Traditional data center cooling is reactive because it ramps up based on ambient or internal temperature sensors. In High-Performance Computing (HPC) and LLM training, thermal spikes occur faster than traditional HVAC systems can respond. Furthermore, cooling distribution is typically uniform across a data center, a rack, or server blades, leading to energy waste in dark or areas.

There is a need for a system that can anticipate thermal loads within a data center based on the computational “intent” of LLM workloads, rather than reactively waiting for actual heat generation.

### SUMMARY

These shortcomings are addressed by the present disclosure of methods, computer program products, and systems for intelligent hierarchical orchestration for preemptive cooling of data centers based on upcoming or scheduled LLM workloads.

In one embodiment, a Cooling Orchestration Middleware (COM) adjusts cooling based on actual LLM workloads, for one or more device processors. The COM bridges the gap between an AI Job Scheduler (the “Intent Layer”) for one or more AI semiconductor chips and a Smart Liquid Distribution Manifold (the “Physical Layer”). To do so, a specific thermal signature of an LLM task is identified (e.g., training vs. inference, transformer-based attention spikes) and coolant flow to specific blades is proactively adjusted via Internet Protocol (IP)-addressable micro-valves before the heat is generated. The manifold can serve rack of server blades, or multiple racks of server blades. In another embodiment, the COM also adjusts internal fans (i.e., inside a server blade) and local external fans (e.g., outside a server blade or rack of server blades).

In another embodiment, the COM adjusts cooling based on actual LLM workloads, for an entire (or section) of a facility. The COM bridges the gap between an AI Job Scheduler for an aggregate of AI semiconductor chips in a facility, and facility cooling systems (e.g., cooling towers, fans and ventilation to outside ambient air).

In still another embodiment, the COM adjusts cooling based on predictions of heat generation from predicted LLM workloads. For instance, a periodicity of LLM training workloads is derived after a few cycles, allowing proactive cooling measures at device and facility levels. One implementation makes intelligent predictions from a specialized LLM trained from historical data of LLM tasks and corresponding heat output.

In yet another embodiment, the COM adjusts cooling based on feedback from actual heat generation. At a processor level, internal temperature sensors and liquid coolant measurements indicate per-processor heating. At a device or rack level, external temperature sensors and combined liquid coolant measurements indicate device and rack heating. At a facility level, computer vision enabled by Infra-Red (IR) or room temperature sensors indicate facility heating (e.g., facility as a whole and rooms or other sections of a facility.

Advantageously, data centers are able to increase processor outputs, while reducing processor throttling.

### DETAILED DESCRIPTION

In the following drawings, like reference numbers are used to refer to like elements. Although the following figures depict various examples of the invention, the invention is not limited to the examples depicted in the figures.

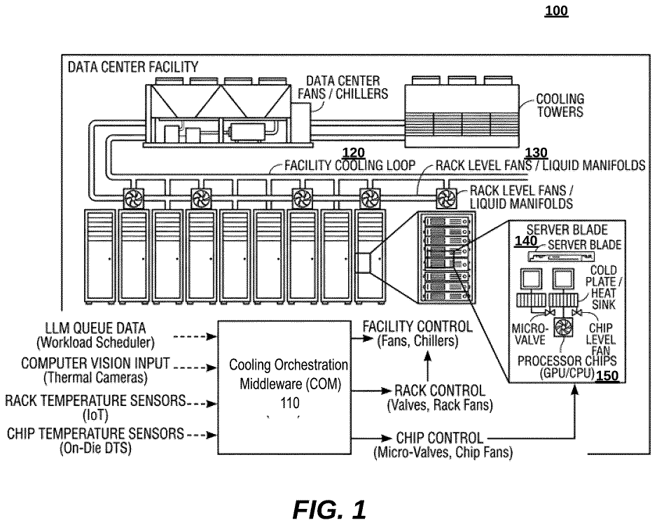

FIG. 1 is a schematic block diagram illustrating the overall data center cooling ecosystem, depicting the hierarchical control architecture managed by the COM, according to the embodiment.

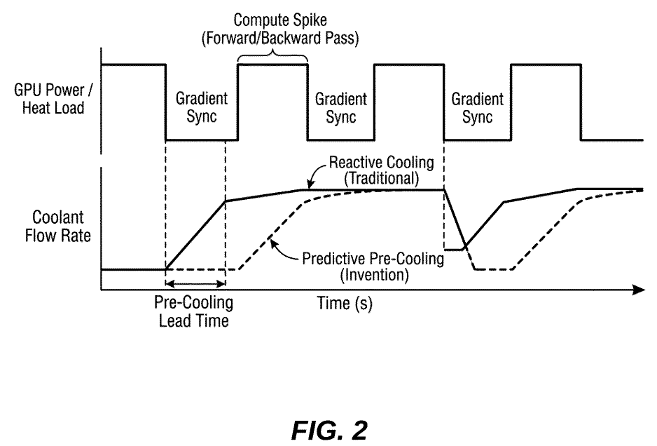

FIG. 2 is a timing diagram contrasting a traditional reactive cooling ramp with a predictive pre-cooling ramp synchronized to an LLM transformer cycle, according to an embodiment.

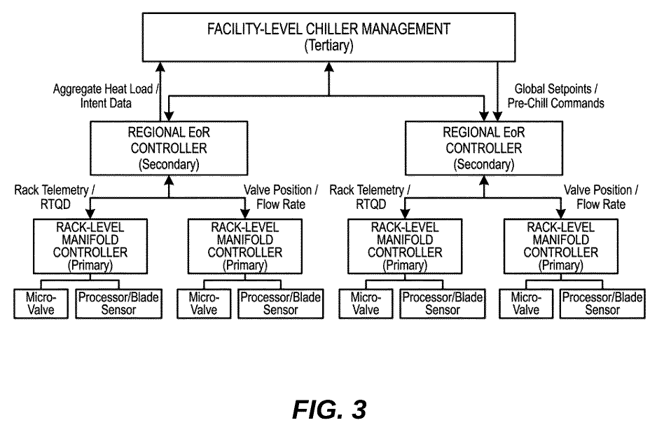

FIG. 3 illustrates a physical hierarchy of components under COM topology, spanning from the rack-level manifold controller to the facility-level chiller management, according to an embodiment.

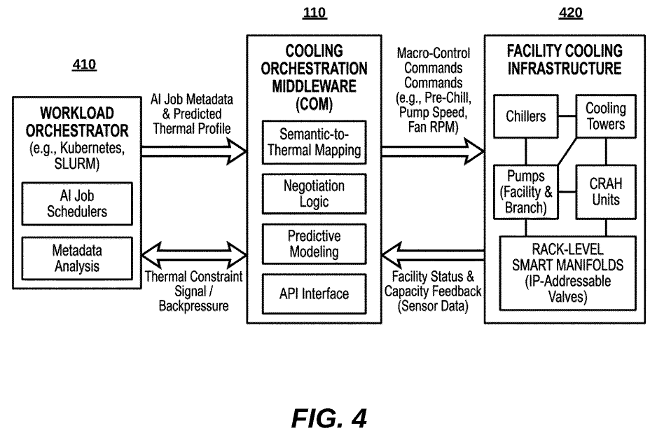

FIG. 4 is a high-level system architecture diagram showing the COM interfacing between a Workload Orchestrator and the facility cooling infrastructure, according to an embodiment, according to an embodiment.

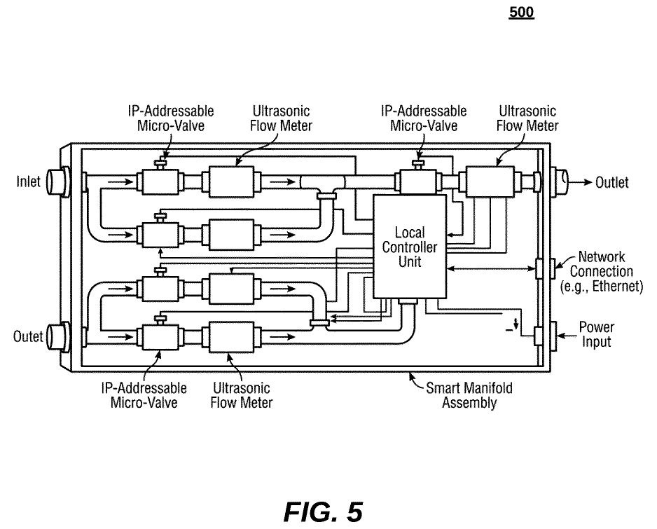

FIG. 5 illustrates a smart manifold assembly, detailing the IP-addressable micro-valves, ultrasonic flow meters, and local controller placement, according to an embodiment.

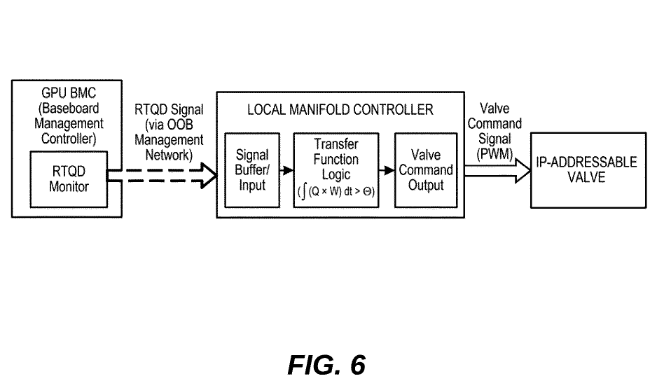

FIG. 6 is a signal flow diagram of the queue-aware trigger, showing the path of the Real-Time Queue Depth (RTQD) signal from the GPU Baseboard Management Controller (BMC) to the local manifold controller, according to an embodiment.

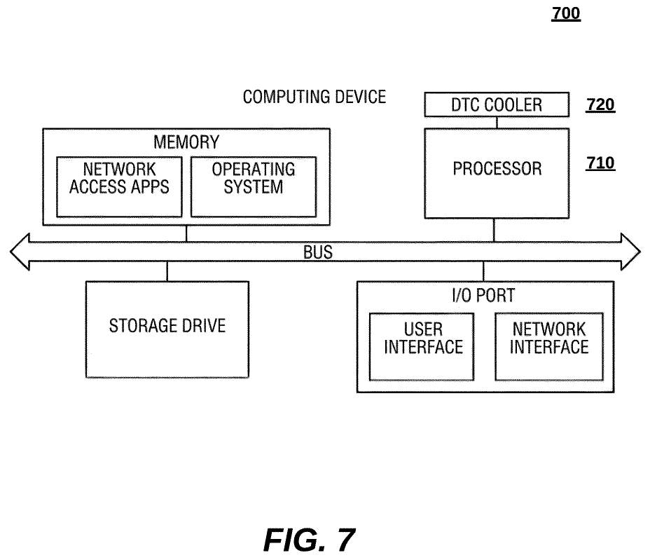

FIG. 7 is a block diagram illustrating a processor-driven computing device, according to an embodiment.

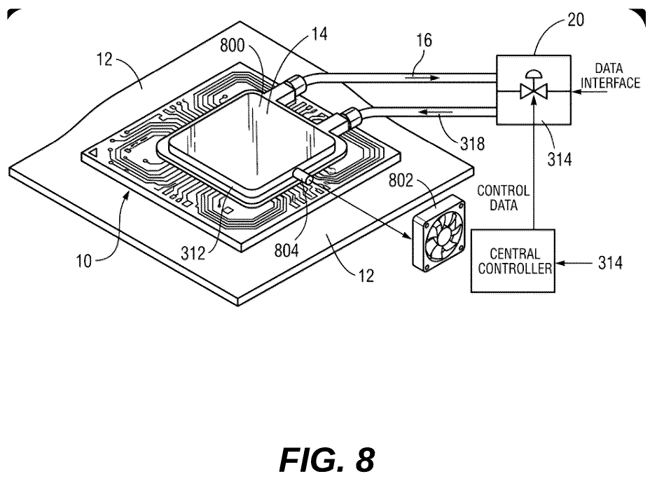

FIG. 8 is a more detailed schematic diagram illustrating a processor with internal cooling, according to an embodiment.

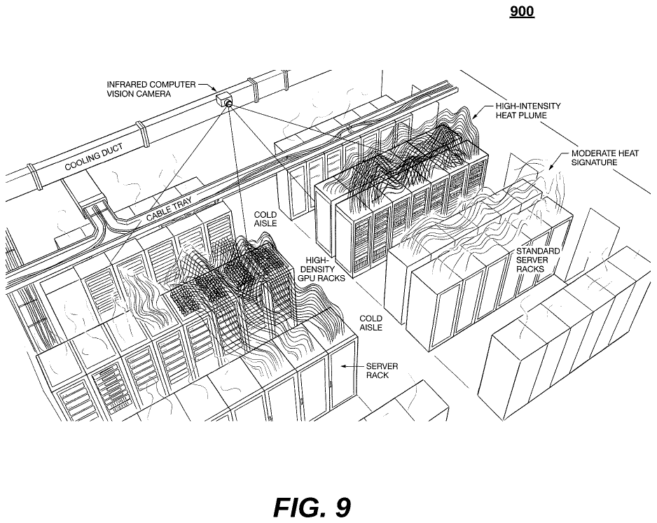

FIG. 9 is a logic flow diagram of the multi-modal SLM Feedback Loop, utilizing computer vision and sensor fusion for predictive error correction, according to an embodiment.

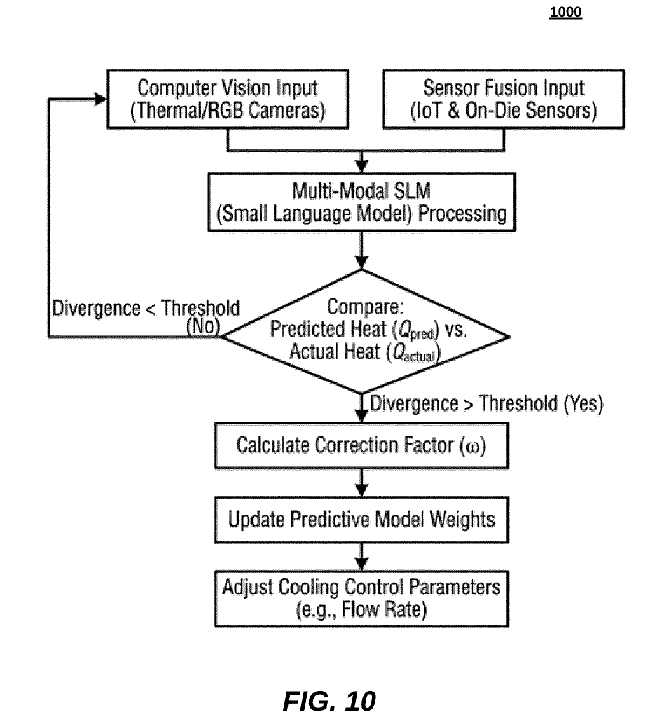

FIG. 10 is a logic flow diagram of the multi-modal SLM feedback loop, utilizing computer vision and sensor fusion for predictive error correction, according to an embodiment.

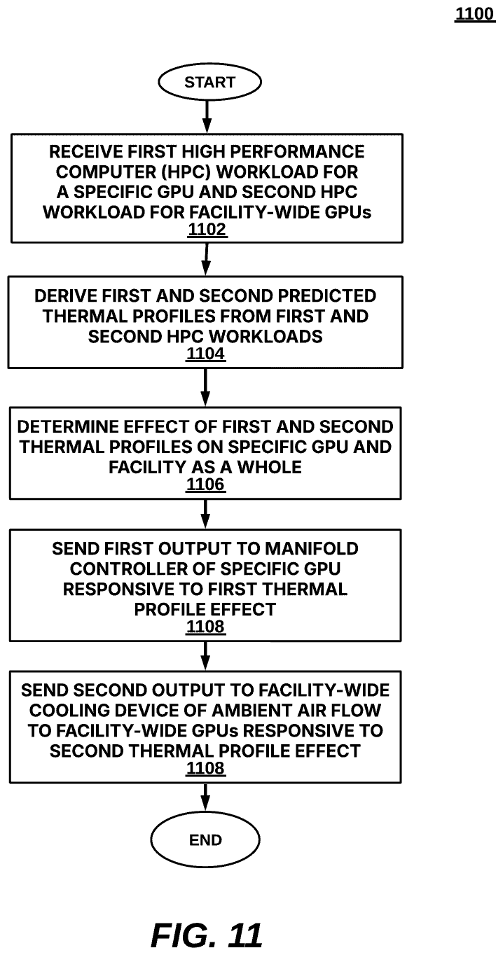

FIG. 11 is a flow chart illustrating a method for integrated facility-wide LLM workload predictive cooling, according to an embodiment.

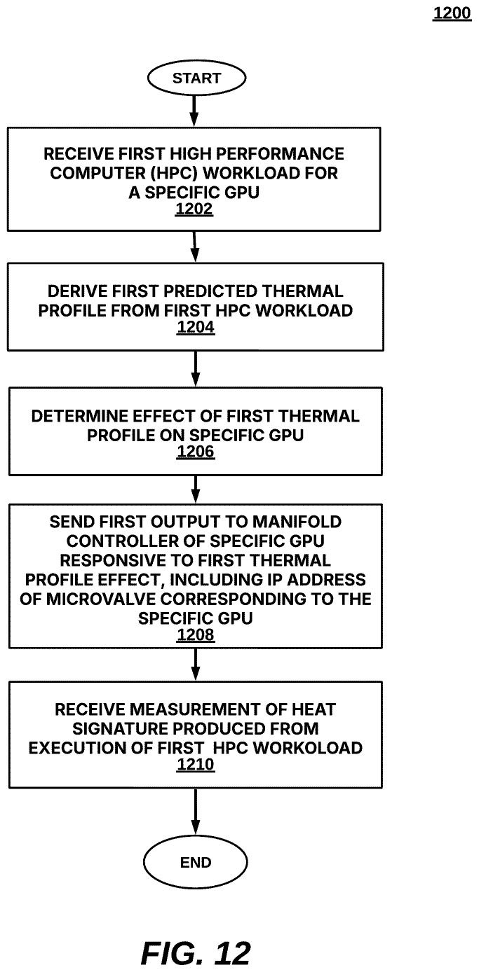

FIG. 12 is a flow chart illustrating a method for rack and device-level LLM workload predictive cooling, according to an embodiment.

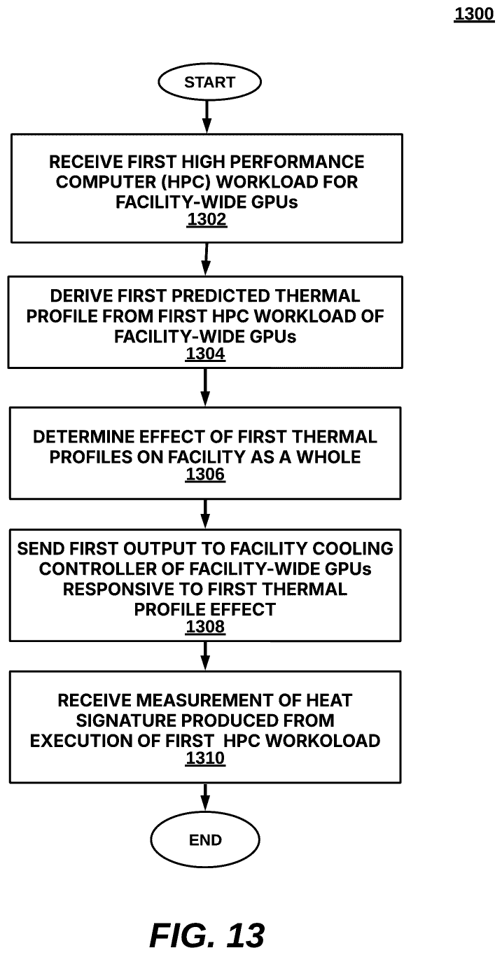

FIG. 13 is a flow chart illustrating a method for facility-level LLM workload predictive cooling, according to an embodiment.

### DETAILED DESCRIPTION

The description below provides methods, computer program products, and systems. Cooling can be based on Real-Time Queue Depth (RTQD) corresponding to upcoming compute needed for specific types of LLM workloads, instead of waiting for a thermal result or consequence.

### I. FACILITY-LEVEL ARCHITECTURE FOR LLM WORKLOAD PREDICTIVE COOLING (FIGS. 1-4)

FIG. 1 is a comprehensive schematic illustrating an overview of the data center facility 100, according to an embodiment. The integration of cooling hardware with control signal pathways across all tiers, is shown, including a facility cooling loop 120, rack (or device) level fans and liquid cooling 130, and server blade 140 with a processor 150. The physical facility cooling loop 120 is depicted connecting exterior fans/chillers and cooling towers, at the facility-level, to rack level fans/liquid manifolds, at the rack-level, to direct-to-chip (DTC) cooling apparatus/internal fans and heat sinks, at the processor-level.

The processor 150 can be a semiconductor chip comprising a graphical processing unit (GPU), a tensor processing unit (TPU), a neural processing unit, a network processing unit, a computer processing unit, an application specific integrated circuit (ASIC), a field programmable gate array (FPGA), or any other appropriate processing unit, without limitation. In one embodiment, the server blade 140 has a single processor, and in other computing devices, has multiple processors. Manufacturers include Nvidia, AMD, Intel, Qualcomm, Broadcom, and others.

The predictive cooling operations by the COM 110 are enabled by an LLM pipeline, prior to execution. Preferably, the AI job scheduler, at a granular or abstract level indicates a thermal profile for preemptive actions. However, some embodiments leverage other lead indicators that occur before AI scheduling, for example, hardware signatures inherent to Extract-Transform-Load (ETL) and/or Extract-Load-Transform (ELT) tasks (high disk I/O and memory controller utilization coupled with low tensor core activity, significant ETL/ELT compute, performance counters and load/store units to detect data being shuffled into the data lake).

FIG. 2 is a timing diagram contrasting traditional reactive cooling with the disclosure's predictive approach during an LLM training cycle. The top graph shows GPU power fluctuating between high-intensity compute spikes and lower-intensity gradient synchronization phases. The bottom graph demonstrates that traditional cooling lags behind the power spike, reacting only after heat is generated. In contrast, the predictive pre-cooling trace initiates a flow ramp during a calculated “lead time” before the compute spike begins, ensuring maximum coolant velocity coincides precisely with the onset of peak thermal load. The lead time can be different with respect to facility-wide cooling, rack-level cooling and individual device or individual GPU cooling.

FIG. 3 is a block diagram illustrating the hierarchical control topology utilized to manage cooling across different data center scales. At the edge, Primary Rack-Level Manifold Controllers manage local micro-valves using direct processor telemetry. These feed data up to Secondary Regional End-of-Row (EoR) Controllers, which aggregate rack data. Finally, a Tertiary Facility-Level Chiller Management system receives aggregate heat load data to determine global setpoints, such as pre-chill commands, which cascade down the hierarchy. This multi-tiered approach ensures low-latency response at the chip level while maintaining holistic, energy-efficient management at the facility level.

A COM 110 executes the control logic for cooling the data center at the various levels. It receives diverse inputs ranging from LLM queue data for workloads (real-time or predicted) to computer vision and chip sensors. After processing, the output includes coordinated commands issued to facility, rack and/or chip-level cooling mechanisms. Modbus-TCP and BACnet/IP can be used for communication with OT cooling hardware.

The COM 110 captures metadata from one or more LLM job queues for one or more processors, at a processor level, at a blade level having multiple integrated processors, at a rack level having multiple blade devices, or an aggregate data center level having multiple racks and multiple rows of racks in one or more rooms. Example metadata includes an AI model size, batch size, and expected GPU utilization.

TABLE 1
Proactive Actions Output of COM from Sensor Input

| Metadata | Leading Indicator | Proactive Result |
|---|---|---|
| Model Size | Total thermal | Pre-chills the facility |
| | reservoir needed | loop 5-10 minutes early |
| Batch Size | Duration of the | Adjusts pump speeds and |
| | heat spike | CRAH fan RPM |
| Metadata | Leading Indicator | Proactive Result |
| Utilization | Speed of the heat | Opens micro-valves before |
| | ramp | heat is generated |

More specifically, and as shown in Table 1, a larger model size of 405 billion (405 B) has a larger number of parameters than a model size of 70 B, requiring significantly more memory and more frequent tensor core activations across multiple GPUs. Thus, the 405 B model will likely trigger a sustained, maximum coolant flow command because the thermal intensity is guaranteed to be high across the entire server rack.

A high batch size has a higher number of training examples or data requests processed simultaneously in one pass through a GPU. This increases the duty cycle of the processors, meaning they stay at peak power for longer durations. If the batch size is massive, a Computer Room Air Handler (CRAH) at the facility-level can be cranked up. If however, the facility-level of cooling are already at 90%, for instance, the COM can predict a thermal wave and may even signal back to the AI Job Scheduler to stagger the start times of these batches to smooth the heat curve and avoid tripping facility alarms.

The GPU utilization is related to floating point pipe duty cycle, such as tensor cores versus standard CUDA cores (e.g., FP32), generates sharper, faster heat ramp than standard data movement tasks. Alternatively, a ratio of tensor cores can be determined. By knowing the expected utilization, a local manifold controller can apply a transfer function to the signal and actuate valves to open before the first batch of instructions finishes its cycle.

Also, from the COM-captured metadata, specific LLM job-types are determined, in some cases. The COM 110 does not read the code itself, but instead identifies Hardware Signatures and Orchestration Metadata. To distinguish between, for instance, a Matrix Multiply (generating high heat) and a Data Move (generating relatively low heat), the COM can monitor specific Performance Counters provided by the processor. The hardware generates a signal indicating the duty cycle of the Tensor Cores. A high activation rate is the definitive signature of an FP16/BF16 Matrix Multiplication (the primary engine of LLMs). A high Memory Controller Utilization is detected from high activity in the Load/Store units (e.g., Load Share Memory (LDSM) and Store Global (STG) operations) with low Tensor core activity indicates a Data Movement or Shuffle operation. Where memory and disk I/O are high, but GPU computer is low, the COM (and/or manifold controller) may command a low-flow state to the GPU and instead divert coolant to the CPU cold plates.

The COM identifies job-types (e.g., Training vs. Inference) through an API handshake with the Workload Orchestrator, as shown as Table 2. Asynchronous Thermal Exchange (ATX) is one API protocol utilized to receive data from software of the Workload Orchestrator like Kubernetes or Simple Linux Utility for Resource Management (SLURM), that schedule which AI jobs run on which chips.

TABLE 2
Thermal Predictions of COM from Job Types

| Job Type | Data Signal Trigger | Thermal Prediction |
|---|---|---|
| LLM | High “All-Reduce” | Sustained Peak: Maximum flow, |
| Training | network traffic + | anticipatory pre-cooling before |
| | 95% Tensor Core | gradient sync. |
| | load. | |
| LLM | High “Request-per- | Transient Spikes: Fast-acting |
| Inference | Second” (RPS) + | micro-valve modulation to |
| | Bursty Tensor | handle “jitter.” |
| | activation. | |
| Data Pre- | High Disk I/O + | Low-Flow State: Divert coolant |
| processing | High CPU + Low GPU. | to CPU cold plates; throttle |
| | | GPU manifold. |
| Job Type | Data Signal Trigger | Thermal Prediction |
| Check- | High NVLink/PCIe | Trough Recovery: Rapidly reduce |
| pointing | traffic + Zero | flow to prevent over- |
| | Compute. | cooling/condensation. |

In more detail, SLURM is a batch-job scheduler preferred for large-scale AI training, operating on a submit-and-wait model wherein users request specific resources (e.g., CPUs, GPUs, memory) via bash scripts (e.g., sbatch). The architecture is centered on a central controller (e.g., slurmctld) that manages a queue and a daemon (slurmd) on each compute node that executes a job. Gang scheduling of all GPUS (e.g., 512 GPUs) for a training run are ensured to be available before the job starts. Message Passing Interface (MPI) is deeply integrated for low-latency communication during gradient synchronization. Kubernetes is preferred for AI inferencing using an architecture of a control plane (e.g., API server, scheduler and etcd database) and worker nodes running kublets that manage containerized pods, as a declarative model where users define a desired state in YAML Ain′t Markup Language (YAML) manifests. An intent can be declare in YAML's human-readable context, such as how many GPUs or server blades are needed, from batch size, utilization and job type parameters.

To minimize decision latency, the placement of the COM is critical, a hierarchical controller topology, of one implementation, includes:

TABLE 3
Functions of Hierarchical Controller Levels

| Controller | | |
|---|---|---|
| Level | Location | Function |
| Primary | On the Rack | Sits within 1 meter of the processors. |
| (Local) | Manifold | Receives RTQD signals and makes micro- |
| | | adjustments to the IP-addressable |
| | | valves. |
| Secondary | End-of-Row | Aggregates data from 20-40 racks. |
| (Regional) | (EoR) | Manages the larger Branch Pumps to |
| | | ensure the entire row has enough |
| | | pressure. |
| Tertiary | Central | Manages the Chillers. It uses the |
| (Facility) | Plant/ | “Intent” data (the job type) to |
| | Cloud | prepare the facility's total thermal |
| | | reservoir. |

In other embodiments, preemptive cooling and thermal prediction inputs from AI job scheduling and inputs from current states, are enhanced by inputs from pre-AI job scheduling pipelines, such as ETL and ELT tasks.

FIG. 4 is a more detailed block diagram illustrating the facility-level control architecture where the COM 110 acts as the central intelligence bridging Workload Orchestrator 410 (Internet Technology (IT) workloads) and Facility Cooling Infrastructure 420 (operational technology (OT) cooling systems).

In doing so, the COM 110 extends its control logic to the top of the hierarchy, interfacing directly with the facility's primary heat rejection units, such as chillers to lower temperature of coolants, cooling towers to use evaporation and fans to release heat outside to ambient air, and Computer Room Air Handlers (CRAHs) to blow air over cooling coils, ceiling fans, and exterior air vents. In one embodiment, specialized data center-specific cooling equipment implemented, such as Variable Frequency Drives (VFDs) that allow chillers and pumps to instantly and precisely adjust speed to match the quickly-fluctuating compute load. In general, data center cooling equipment focuses on heat rejection of spiky and volatile heat generation, over a high-density footprint. The COM 110, in some embodiments, is aware of OT equipment and their parameters and capabilities, such as VFD equipped OT, when developing cooling strategies.

The COM 110 issues macro-commands to facility-level units. As result, non-limiting facility temperature control events include, ambient air is further cooled or cease cooling, air vents to exterior outside air are opened or closed, specific air vents on ducts for interior-generated cooling are opened or closed at specific locations (e.g., opened responsive to hot spots and closed responsive to cold spots, predicted or measured).

For determining output commands, the COM 110 uses internal semantic mapping, and at times, its own predictive modeling to proactively issue macro-control commands-such as pre-chilling loops or adjusting pump speeds-to the facility infrastructure. For example, the output (e.g., OT Side) can include Chiller Setpoint Write: BACnet Object: Analog Value: Supply_Temp_Setpt->Lower by 2 degrees; or Pump Speed Write: Modbus Register: 40001 (VFD_Speed)->Increase to 90 Hz. The COM can also send thermal constraint or backpressure signals back to the scheduler if cooling capacity is exceeded, based on real-time feedback from facility sensors.

The COM 110 can identify which sections of a facility, such as which rooms or which rows will have the highest “air-side leakage” based on the job type, in an embodiment. Even with direct-to-chip liquid cooling, approximately 20-30% of the heat (from VRMs, DIMMs, and switches) still escapes into the air. In response, the COM 110 can orchestrate the specific CRAH units facing those rows with a command increase fan speed (i.e., RPM) and air pressure before the heat saturates the aisle. This prevents hot spots from forming in the upper sections of the racks.

In some cases, the COM 110 receives predictive AI job metadata from the Workload Orchestrator 410, which can use AI and other predictive technologies based on real-time queue depth, local processing loads, types of processors, and other local hardware and software data available to the Workload Orchestrator 410 that may not be passed upstream to the COM 110.

Meanwhile, the COM 110 can have its own predictive aspects for global facility OT. As a result of individual racks spike and trough, the data center as a whole experiences an aggregate thermal wave. Large chillers have high thermal inertia, making it difficult to spin up instantly. If 50% of the data center starts a massive training run simultaneously, the return water temperature (fluid returning to the chiller) will spike before the chiller has ramped up, potentially tripping high-pressure alarms. In one case, under the current techniques, the COM calculates the Global Thermal Vector−the sum of all scheduled predicted_tdp_watts from the Kubernetes/Slurm scheduler. A pre-chill command can be sent to the facility BMS 5-10 minutes before the aggregate job start time. This lowers the coolant supply temperature by 2-3 °C anticipatorily, creating a thermal buffer in the primary loop. In one use case, the COM 110 correlates the job start time and duration with External Weather Data. For example, if a 4-hour training job is scheduled and the outside temperature is dropping (e.g., evening), the COM 110 delays the chiller ramp-up and instead commands the Economizers (fresh air intakes) to open 100%, using the free outside.

In one embodiment, the Facility Level Infrastructure 420 feeds back input to the COM 110. In one case, the cooling system may have to throttle due to power requirement limitations. When LLM workloads pick-up a power spike to the GPUs increases at the same time that power needs for cooling increases. If the facility cooling system is unable to secure enough guaranteed power for necessary cooling, it can send a message back to the COM 110 to resolve the conflict. In another embodiment, a message is sent directly from the cooling system to AI schedulers to throttle the GPUs, thereby reducing the power conflict. As a result, the AI schedulers (or an intermediary logic or intelligence) can rearrange the LLM jobs in a power-aware manner. In another embodiment, AI schedulers rearrange the LLM jobs in a thermal-aware manner. In a further embodiment, failure in the facility cooling system causes an urgent downshift or rearrangement in LLM jobs, and/or an immediate increase in rack-level and device-level cooling.

### II. RACK-LEVEL ARCHITECTURE FOR LLM WORKLOAD PREDICTIVE COOLING (FIGS. 5-6)

FIG. 5 depicts a schematic cross-section of the rack-level Smart Manifold Assembly 500. The assembly manages coolant distribution through parallel fluid branches, each equipped with an IP-addressable micro-valve for precise flow throttling and an ultrasonic flow meter for real-time verification. A central Local Controller Unit aggregates data from the flow meters and actuates the micro-valves based on commands received via an external network connection, such as Ethernet. This integrated design allows for granular, independent thermal management of individual server blades served by the manifold's outlets.

Each individual cooling branch (per blade or per GPU) is equipped with a dedicated Actuated Proportional Valve (APV). A rack level cooling system, for example by Supermicro, can include a central distribution unit (CDU), cold plats, coolant distribution manifolds (CDMs), hose kits and quick disconnect couplings (QDCs) and external infrastructure (e.g., cooling towers and dry coolers).

Each valve unit contains a local microcontroller (e.g., an ARM-based chip) with an RJ45 or wireless interface, allowing it to exist as a discrete node on the Data Center network. Unlike open/closed solenoids, these valves use a stepper motor to provide proportional flow, allowing the system to deliver exactly 2.5 liters/min to a high-load GPU while maintaining a trickle flow of 0.2 liters/min to an adjacent idle CPU, in one case. Non-invasive sensors that verify the valve has actually reached the requested flow rate without obstructing the fluid path. Differential pressure sensors monitor the pressure drop across the cold plate. A sudden drop in pressure at a specific valve can trigger an Automated Isolation Protocol to prevent a leak from cascading.

In one embodiment, a fail-safe mechanical override component protects critical devices from catastrophic failure. In more detail, a passive-open Spring Return includes valves designed with a mechanical bias. In the event of a total control signal loss or power failure to the manifold, the valves automatically spring to the 100% open position. This ensures that while efficiency is lost, the hardware is protected by maximum available cooling.

The instruction-to-cooling logic flow starts with orchestrator tagging a new container as, for instance, “LLM TRAINING 70B.” BMC monitors the Instruction Queue Depth and sees a massive batch of Matrix Multiply kernels. BMC sends a “High-Intensity Intent” packet to the Local Manifold Controller. Controller looks up the “Thermal Profile” for that job type and calculates the liters/min needed. Controller issues a command to the IP-addressable valves to open 100% before the first Matrix Multiply completes its first cycle.

In more detail, within the hardware, a queue-aware trigger signal is sent from the BMC or System-on-Chip (SoC) Monitor extracts the counters. The signal can be sent via an out-of-band management bus (e.g., NC-SI or I3C) directly to the Local Manifold Controller. The Local Manifold Controller can be physically integrated into the Rack Manifold Assembly. This ensures that the decision-to-valve-action latency is in the millisecond range, whereas the COM would have second-level latency. The signal can be a high-frequency telemetry stream (typically via PCIe VDM or I3C) that reports the number of pending Kernels or Warp Commands currently residing in the GPU's command processor buffer.

Real-time flow meters, in an embodiment, include a flow feedback loop that reports back to the COM to ensure the requested “Thermal Budget” is being delivered. As a result, if a specific blade is idle during a distributed training run (e.g., a “straggler” node), the COM commands the micro-valve to a minimum bypass state, saving pump energy and increasing pressure for active nodes.

FIG. 6 is a block diagram illustrating rack-level or processor-level signal flow for the queue-aware trigger, enabling anticipatory cooling based on computational demand. A monitor within the GPU's BMC transmits a RTQD signal via an out-of-band management network to the Local Manifold Controller. The controller buffers this signal and applies a transfer function, integrating queue depth and instruction weight over time against a thermal threshold. If the threshold is exceeded, the controller generates a Pulse-Width Modulation (PWM) command signal to immediately actuate the IP-addressable valve prior to significant heat generation.

In another case, LLM training can have predictable burst patterns during gradient synchronization. The COM and/or manifold controller utilizes these patterns for pre-flow to increase coolant flow velocity 5-10 seconds prior to a scheduled compute burst. Additionally, thermal buffering utilizes the heat capacity of the coolant in the pipes as a thermal flywheel to absorb transient spikes without tripping facility-level alarms. In another embodiment, LLM inferencing is predicted based on real-time parameters and dynamic characteristics. LLM training typically involves forward pass of high GPU compute (High Heat), backward pass of maximum GPU compute (Peak Heat), and all-reduce/gradient sync of high Network I/O, lower GPU compute (Cooling Trough). The algorithm can calculate the Periodicity of these and other cycles. For instance, if periodicity is 45 seconds, the cooling system does not wait for the temperature to rise at second 1, it begins ramping the IP-addressable valves at second −5.

The algorithm identifies a signature by monitoring the power draw patterns of the first 10 cycles to create a digital thermal twin of the specific LLM being trained. Based on the liquid's velocity and the distance from the manifold to the cold plate, the algorithm calculates the transport delay. It then commands the smart valves to open ahead of the next forward Pass to ensure fresh, chilled coolant is already at the micro-channels when the transistors switch. If the network experiences latency (stalling the training), the algorithm detects the drop in power and holds the cooling ramp to prevent over-cooling and condensation.

### III. DEVICE-LEVEL ARCHITECTURE FOR LLM WORKLOAD PREDICTIVE COOLING (FIGS. 7-8)

FIG. 7 is a block diagram illustrating the general architecture of a computing device 700 with a processor 710 having a DTC cooler 720. It features a processor, memory containing a network access app and operating system, and a storage drive. The computing device 700 includes an I/O port with a user interface and network interface. A bus connects all these components, enabling communication and data transfer within the system. The computing device 700 can be a main component for LLM workloads (e.g., server blade), or a peripheral unit for the COM 110 or an SLM, for example.

FIG. 8 is a schematic diagram depicting, at a processor-level, a hybrid thermal management system 10. A processor 312 mounted on a motherboard 12 is thermally coupled to a DTC cold plate 800. Coolant supply and return lines 16, 318 connect the cold plate to a flow control unit 20. A central controller 314 receives real-time temperature data directly from the processor and issues simultaneous control signals to modulate the flow control unit 20 and adjust the speed of an internal air-cooling fan 804, enabling coordinated liquid and air cooling.

### IV. ADAPTIVE ERROR-CORRECTION FOR LLM WORKLOAD PREDICTIVE COOLING (FIGS. 9-10)

FIG. 9 is a perspective view of a data center interior 900 illustrating the computer vision-based thermal verification layer, according to an embodiment. Cooling ducts can provide uniform air flow or selective airflow by opening and closing certain vents, and ramping up and down air pressure to certain trunks of the cooling ducts.

An infrared computer vision camera is shown mounted to the ceiling infrastructure (e.g., a cable tray or truss), positioned to monitor the white space or cold aisles between rows of Server Racks. The drawing depicts thermal plumes as wavy contour lines rising from the exhaust vents of the server racks. The visualization represents the seen heat data captured by the thermal-spectrum cameras. The illustration differentiates between workload intensities through the density of the thermal lines of high-intensity zones, low-intensity zones and spatial awareness.

In more detail, racks processing heavy AI training workloads (e.g., high-density GPU racks) are depicted with dense, turbulent, and high-reaching thermal plumes, indicating a significant heat rejection load. Adjacent racks (e.g., standard server racks or idle nodes) are shown with sparse or non-existent thermal lines, indicating a low-power or idle state. The field of view covers multiple racks and aisles, illustrating the system's ability to detect spatial thermal gradients and hot spots that may not be captured by internal on-die sensors alone.

FIG. 10 is a logic flow diagram for the multi-modal Small Language Model (SLM) feedback loop used for adaptive error correction. The system ingests real-time data from computer vision systems (thermal/RGB cameras) and fused sensor inputs (connected thermometers, IoT, on-die DTS) to establish ground-truth thermal conditions. The SLM compares this actual detected heat against the scheduler's predicted heat. If the divergence exceeds a predefined threshold, the SLM calculates a correction factor and updates the predictive model weights, automatically adjusting future cooling control parameters (or retraining the SLM) to resolve the discrepancy.

### V. METHODS FOR LLM WORKLOAD PREDICTIVE COOLING (FIGS. 11-13)

The following flowcharts illustrate the logic and method steps executed by, for example, a COM and associated hardware components to achieve intent-based, predictive thermal management.

FIG. 11 is a flow chart illustrating a method 1100 for integrated facility-wide LLM workload predictive cooling, according to an embodiment. This method demonstrates the hierarchical capability of the COM to manage both micro-level (chip) and macro-level (facility) cooling simultaneously based on workload intent.

At step 1102, the process begins when the COM receives a first HPC workload for a specific GPU and a second HPC workload for facility-wide GPUs. This data is typically ingested from a Workload Orchestrator (e.g., Kubernetes or SLURM) and includes AI Job metadata such as model size or batch size. At step 1104, the COM derives first and second predicted thermal profiles from the first and second HPC workloads. This involves Semantic-to-Thermal mapping where specific job types (e.g., LLM Training vs. Inference) are translated into expected heat generation values. At step 1106, the system determines the effect of these thermal profiles on the specific GPU and the facility as a whole. For example, the system calculates if the specific GPU workload will require a specific flow rate of coolant, while simultaneously calculating if the aggregate facility workload will create a thermal wave that saturates the facility's cooling loop. At step 1108, Responsive to the first thermal profile effect, the COM sends a first output to a manifold controller of the specific GPU. This output commands the local hardware to adjust coolant flow, specifically targeting the DTC cooling elements. At step 1110, simultaneously or sequentially, the COM sends a second output to a facility-wide cooling device to control ambient air flow to facility-wide GPUs, responsive to the second thermal profile effect. This may involve adjusting CRAH fan speeds or chiller setpoints to mitigate air-side thermal leakage or prepare a thermal buffer for the aggregate load.

FIG. 12 is a flow chart illustrating a method 1200 for rack and device-level LLM workload predictive cooling, according to an embodiment. This method focuses on the granular control of the Smart Liquid Distribution Manifold.

At step 1202, the system receives a first HPC workload for a specific GPU. This may be triggered by a high-intensity intent packet sent from a BMC. At step 1204, the COM derives a first predicted thermal profile from the first HPC workload. The system identifies specific hardware signatures, such as high Tensor Core activation indicating a Matrix Multiplication task, which predicts a sharp heat ramp. At step 1206, the system determines the effect of the first thermal profile on the specific GPU. This step may include calculating the “Lead Time” required to ramp coolant flow so that maximum velocity coincides with the compute spike. At step 1208, the COM sends a first output to the manifold controller of the specific GPU responsive to the thermal profile effect. Crucially, this output includes the IP address of the micro-valve corresponding to the specific GPU. By using IP-addressable valves, the system ensures that coolant is delivered proportionally only to the blade generating heat, while adjacent idle nodes may remain at a trickle flow. At step 1210, finally, the system receives a measurement of the heat signature produced from the execution of the first HPC workload. This feedback, potentially from on-die sensors or ultrasonic flow meters, verifies that the thermal budget was delivered and allows for error correction.

FIG. 13 is a flow chart illustrating a method 1300 for facility-level LLM workload predictive cooling, according to an embodiment. This method addresses the high thermal inertia of large cooling infrastructure.

At step 1302, the system receives a first HPC workload for facility-wide GPUs. This represents the aggregate intent data, or the “Global Thermal Vector,” of the data center. At step 1304, the COM derives a first predicted thermal profile from the first HPC workload of the facility-wide GPUs. This prediction accounts for factors like the periodicity of LLM training cycles across thousands of chips. At step 1306, the system determines the effect of these thermal profiles on the facility as a whole. This involves predicting potential high-pressure alarms or return water temperature spikes that traditional reactive systems might miss. At step 1308, the COM sends a first output to a facility cooling controller of the facility-wide GPUS responsive to the first thermal profile effect. Commands may include pre-chill instructions to lower the coolant supply temperature by 2-3 °C minutes before the workload begins. At step 1310, the system receives a measurement of the heat signature produced from the execution of the first HPC workload. This can be achieved using infrared computer vision cameras to detect heat plumes and verify if the macro-cooling adjustments successfully mitigated hot spots.

### VI. GENERALITIES OF THE DISCLOSURE

Description of key terms used in the disclosure:

Cooling Orchestration Middleware (COM): A software layer that interfaces between the AI workload scheduler and the physical cooling infrastructure to translate computational intent into thermal management commands.

Smart Liquid Distribution Manifold: The physical assembly at the rack level containing IP-addressable micro-valves and flow meters to manage coolant delivery to individual blades.

Real-Time Queue Depth (RTQD): A signal representing the number of pending kernels or warp commands in a GPU's command processor buffer, used as a leading indicator for thermal spikes.

Digital Thermal Twin: A predictive model created by monitoring the power draw patterns of initial training cycles to forecast future heat generation.

Asynchronous Thermal Exchange (ATX): The API protocol used for the negotiation of thermal capacity between the workload scheduler and the cooling controller.

Small Language Model (SLM): A lightweight AI model deployed on the edge controller used to fuse sensor data and provide predictive error correction for the cooling system.

Thermal Lead Time: The calculated time required for coolant to travel from a valve to a cold plate, used to synchronize flow increases with compute spikes.

Intent-Based Cooling: A control strategy that proactively adjusts cooling based on the metadata and schedule of upcoming workloads rather than reacting to current temperature readings.

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use.

The scope of the invention is defined by the following claims.

I claim:

1. A Cooling Orchestration Middleware (COM), implemented at least partially in hardware, for multi-level, intent-based thermal management of upcoming High-Performance Computing (HPC) workloads, comprising:
a processor;
an input/output board, communicatively coupled to the processor; and
a memory, storing computer-executable code, that is executed by the processor to:
receive a first HPC workload of a specific Graphics Processing Unit (GPU) within a facility and a second HPC workload of a plurality of GPUS, including the specific GPU, within the facility, wherein the first and second HPC workloads are derived from a Large Language Model (LLM) during artificial intelligence (AI) processing;
derive a first predicted thermal profile of the HPC workload of the specific GPU and a second predicted thermal profile of the HPC workload of the plurality of GPUs within the facility;
determine an effect of the first predicted thermal profile on a current thermal profile of the specific GPU and an effect of the second predicted thermal profile on the facility;
send a first output to a local manifold controller that controls a direct-to-chip (DTC) coolant flow to specific GPU responsive to the first thermal profile effect, prior to executing the first LLM workload; and
send a second output to a facility-wide cooling device that controls ambient air flow to the plurality of GPU, responsive to the second thermal profile effect.

2. The COM of claim 1, wherein deriving the first and second thermal profiles comprise identifying types of LLM jobs.

3. The COM of claim 1, wherein deriving the first and second thermal profiles comprise identifying parameters of LLM jobs.

4. The COM of claim 1, wherein sending the second output comprises sending the second output to a facility-wide cooling device that controls airflow to the plurality of GPUS responsive to the second thermal profile, prior to execution of the second LLM workload.

5. The facility-wide coolant controller system of claim 1, wherein the first and second LLM workloads comprise one or more of: AI training, AI inferencing, and date moves.

6. The COM of claim 1, wherein at least the first or second LLM workloads comprise AI inferencing, and wherein a type of AI training comprises one or more of a forward pass, a backward pass, and a gradient synchronization phase.

7. The COM of claim 1, wherein the local manifold controller comprises a plurality of microvalves, each Internet Protocol (IP)-addressable to adjust coolant delivered one or more of the plurality of GPUS.

8. The COM of claim 1, wherein sending the second output to the facility-wide cooling device comprises sending the second output to the facility-wide cooling device to mitigate air-side thermal leakage predicted from the first predicted HPC workload.

9. The COM of claim 1, wherein sending the second output to the facility-wide cooling device comprises sending the second output to the facility-wide cooling device to mitigate air-side thermal leakage predicted from the second predicted HPC workload.

10. The COM of claim 1, wherein a job type of the first HPC workload comprises an AI training job, and the first predicted thermal profile comprises deriving a periodicity of phases of the AI training job, wherein the periodicity further defines a timing of the first output.

11. The COM of claim 1, further comprising: send a signal to throttle the specific GPU responsive to receiving an actual thermal profile that exceeds a predetermined limit.

12. The COM of claim 1, further comprising: send a signal to throttle at least portion of the plurality of GPUS responsive to receiving an actual thermal profile that exceeds a predetermined limit.

13. The COM of claim 1, further comprising: prior to receiving the first or second AI HPC workloads, receive an Extract-Transform-Load (ETL) and/or an Extract-Load-Transform (ELT) hardware signature indicative of upcoming AI job scheduling.

14. The COM of claim 1, wherein deriving the affect first and/or second predicted thermal profile further comprises: prior to receiving the first or second AI HPC workloads, receive an Extract-Transform-Load (ETL) and/or an Extract-Load-Transform (ELT) hardware signature indicative of upcoming AI job scheduling after the first or second AI HPC workloads, and including as a factor in deriving a longer-term affect of the first and/or second predicted thermal profiles.

15. The COM of claim 1, wherein the first HPC LLM workload is, at least in part, received in an out-of-band telemetry stream via a sideband bus bypassing a host operating system of the GPU to minimize signal latency.

16. A computer-implemented method in a Cooling Orchestration Middleware (COM), implemented at least partially in hardware, for multi-level, intent-based thermal management of upcoming High-Performance Computing (HPC) workloads, comprising:
receiving a first HPC workload of a specific Graphics Processing Unit (GPU) within a facility and a second HPC workload of a plurality of GPUs, including the specific GPU, within the facility, wherein the first and second HPC workloads are derived from a Large Language Model (LLM) during artificial intelligence (AI) processing;
derive a first predicted thermal profile of the HPC workload of the specific GPU and a second predicted thermal profile of the HPC workload of the plurality of GPUs within the facility;
determine an effect of the first predicted thermal profile on a current thermal profile of the specific GPU and an effect of the second predicted thermal profile on the facility;
send a first output to a local manifold controller that controls a direct-to-chip (DTC) coolant flow to specific GPU responsive to the first thermal profile effect, prior to executing the first LLM workload; and
send a second output to a facility-wide cooling device that controls ambient air flow to the plurality of GPU, responsive to the second thermal profile effect.

17. A non-transitory computer-readable medium, storing computer-executable code that, when executed by a processor, performs a method for multi-level, intent-based thermal management of upcoming High-Performance Computing (HPC) workloads, comprising:
receiving a first HPC workload of a specific Graphics Processing Unit (GPU) within a facility and a second HPC workload of a plurality of GPUs, including the specific GPU, within the facility, wherein the first and second HPC workloads are derived from a Large Language Model (LLM) during artificial intelligence (AI) processing;
deriving a first predicted thermal profile of the HPC workload of the specific GPU and a second predicted thermal profile of the HPC workload of the plurality of GPUs within the facility;
determining an effect of the first predicted thermal profile on a current thermal profile of the specific GPU and an effect of the second predicted thermal profile on the facility;
sending a first output to a local manifold controller that controls a direct-to-chip (DTC) coolant flow to specific GPU responsive to the first thermal profile effect, prior to executing the first LLM workload; and
sending a second output to a facility-wide cooling device that controls ambient air flow to the plurality of GPU, responsive to the second thermal profile effect.
